(19) United States
(12) Patent Application Publication
(10) Pub. No.: US 2015/0078054 A1
(43) Pub. Date: Mar. 19, 2015

(54) COMMON MODE INDUCTOR DEVICE

(71) Applicant: Eltek AS, Drammen (NO)

(72) Inventors: Erik Myhre, Asker (NO); Thomas Olsen, Asker (NO); Jan Tore Brastad, Drammen (NO); Håkon Hafnor, Drammen (NO)

(21) Appl. No.: 14/391,573

(22) PCT Filed: Apr. 4, 2013
(86) PCT No.: PCT/EP2013/057089

§ 371 Date: Oct. 9, 2014

Related U.S. Application Data
(60) Provisional application No. 61/623,277, filed on Apr. 12, 2012.

(30) Foreign Application Priority Data
Apr. 12, 2012 (GB) 1206474.7

(51) Int. Cl. H01F 27/28; H01F 27/24; H02M 7/44; H01F 27/06

(52) U.S. Cl. CPC H01F 27/2895; H01F 27/06; H01F 27/24; H02M 7/44
USPC 363/140; 336/220; 336/65

(57) ABSTRACT

A common mode inductor device includes a magnetic core forming a continuous loop, a first winding wound around the magnetic core, and a second winding wound around the magnetic core. The magnetic core further includes a first leg section, a second leg section, a third leg section and a fourth leg section. The first winding is wound around the first leg section, the second winding is wound around the second leg section, the third leg section is provided between a first end area of the first leg section and a first end area of the second leg section, and the fourth leg section is provided between a second end area of the first leg section and a second end area of the second leg section.

### CROSS-REFERENCE TO RELATED APPLICATIONS

This application is a National Stage Application of International Patent Application No. PCT/EP2013/057089, filed on Apr. 4, 2013, which claims priority pursuant to Article 8 of the Patent Cooperation Treaty, 35 U.S.C. §119(a), and 119(e) to United Kingdom Patent Application No. 1206474.7 and U.S. Provisional Patent Application No. 61/623,277, respectively, both filed on Apr. 12, 2012. Each of the above-cited priority applications are hereby incorporated by reference in their entireties.

### BACKGROUND

Several types of converters are known for use in power supply systems, where there is a need to convert an AC power to a controlled DC power. The AC power will usually be supplied from an AC power source, such as the mains. The DC power is supplied to equipment such as telecommunication equipment, broad band data communication equipment (GSM/UMTS base stations etc), military equipment, medical equipment etc.

There are several requirements for such power supply systems. First of all, the efficiency should be high, i.e. the losses should be low. The power supply system described in WO 2009/028954 and WO 2009/058024 has an efficiency of ca 96% and is marketed and sold by Eltek Valere under the name FlatPack 2 HE. The power supply system is provided as a power supply unit for insertion into a rack. The unit has an height of 1U (the standard height of one shelf in a rack, corresponding to 44.5 mm), a length of 328 mm and a width of 109 mm so that four such units may be provided next to each other in a 19″ rack. The unit may deliver a power of 2 kW or 3 kW at −48V DC.

One or more embodiments of the present invention provide a smaller unit having substantially the same power as the above power supply system and with a relatively high efficiency. More specifically, the new unit should be 1U high. The length should be 220 mm so that the unit and the rack may be provided in a 30 cm power cabinet. In addition, the width should be 72 mm in order to provide that six such units may be provided next to each other in a 19″ rack. The unit should be able to supply a power of 2-3000 W at −48V DC. Hence, the available volume for the components is reduced by approximately 55%.

One or more embodiments of the invention reduce costs. One contribution to cost reduction is the reduced size. Another contribution to cost reduction is to use cheaper electronic components such as processor units etc. However, such electronic components are simpler, and consequently, effort must be put into using the electronic components smarter. One way of achieving this is to reduce the number of calculations needed for controlling the power supply system.

The power supply system comprises a fan for blowing air through the unit. The fan is normally located on the front side of the unit and blows air out through the rear side of the unit. The increased power density (power per volume unit) of the unit makes it difficult to achieve a satisfying air flow through the unit.

In order to be able to achieve the above, a redesign of the printed circuit card and the organization of the electronic components were necessary. Some of the largest components in such power supply systems are the common mode inductor devices, of which the power supply system must have three (two on the primary side of the converter and one on the secondary side of the converter).

A common mode inductor device, often referred to as a common mode choke, is used to prevent electromagnetic interference (EMI) and radio frequency interference (RFI) from power supply lines and for preventing of malfunctioning of electronic equipment. They pass differential currents (i.e. equal currents, but opposite directions), while blocking common-mode currents.

A photo of a prototype of the power supply unit 1 having the desired size of 1U high, 220 mm long and 72 mm wide is shown in FIG. 1. The unit has a first side plate 3a, a second side plate 3b and a bottom plate 3c with a printed circuit board 2. In FIG. 1, the roof plate of the unit is removed. Three prior art common mode inductor devices 10 are standing on the printed circuit board 2 between the first side plate 3a and the second side plate 3b in order to illustrate the dimensions of the common mode inductors 10 in relation to the available space. As shown, the common mode inductors 10 will obstruct the air flow through the converter. This is especially the case when the power is high, such as 2500 W or higher, since the size of the common mode inductor devices increases as the power increases.

A prior art common mode inductor device 10 is shown in FIG. 2. The common mode indictor device 10 comprises a torus-shaped core 11 of a magnetic material, a first winding 21 wound around the core and a second winding 22 wound around the core. The ends of the windings are guided through openings in the printed circuit board 2 and are electrically connected to the printed circuit board 2.

One or more embodiments of the invention provide an improved common mode inductor device which contributes to solving the above problems and which makes it possible to provide a power supply unit with the specifications mentioned above.

### SUMMARY

One or more embodiments of present invention relates to a common mode inductor device including a magnetic core forming a continuous loop, a first winding wound around the magnetic core and a second winding wound around the magnetic core. The magnetic core includes a first leg section, a second leg section, a third leg section and a fourth leg section. The first winding is wound around the first leg section, the second winding is wound around the second leg section, the third leg section is provided between a first end area of the first leg section and a first end area of the second leg section, and the fourth leg section is provided between a second end area of the first leg section and a second end area of the second leg section.

In one aspect, the first leg section is provided substantially in parallel with the second leg section.

In one aspect, the first leg section, the second leg section, the third leg section and the fourth leg section is forming a rectangular prism with an opening, where edges of the leg sections are chamfered or rounded.

In one aspect, the inductor device further including a separation plate provided between the first winding and the second winding.

In one aspect, the separation plate is fixed between the third and fourth leg sections.

In one aspect, the inductor device further including a mounting plate connected to the fourth leg section.

In one aspect, the mounting plate includes openings, where terminals of the first winding and terminals of the second winding are guided through the openings in the mounting plate.

In one aspect, the third leg section includes an outer, substantially planar contact surface.

In one aspect, the magnetic core is made of a press-moulded magnetic powder.

In one aspect, the respective ends of the first and second winding are provided adjacent to the fourth leg section.

In one aspect, the fourth leg section includes a base element protruding away from the first and second leg sections, where the base element includes an outer, substantially planar contact surface.

In one aspect, the width of the third leg section is larger than the width of the first leg section.

In one aspect, the cross sectional area of the core is substantially constant around its circumference.

In one aspect, the rear surface of the core is planar.

One or more embodiments of the present invention also relates to a power supply unit including a housing including a roof plate, a bottom plate, two side plates, a rear plate and a front plate. An AC-DC converter including electronic components is connected to a printed circuit board, where the electronic components of the AC-DC converter and the printed circuit board are provided within the housing. The AC-DC converter includes at least two common mode inductor devices according to those described above, where the common mode inductor devices are connected to the printed circuit board.

In one aspect, the outer, substantially planar contact surface of the third leg section is provided in contact with the roof plate.

In one aspect, a heat conducting and electrically insulating material is provided between the outer, substantially planar contact surface of the third leg section and the roof plate.

In one aspect, the base element of the fourth leg section is supported in an opening of the printed circuit board.

### BRIEF DESCRIPTION OF THE DRAWINGS

Embodiments of the invention will now be described in detail with reference to the enclosed drawings, where:

FIG. 1 is a photo of a prototype of the new power supply system, wherein prior art common mode inductor devices are used;

FIG. 2 is illustrates one prior art common mode inductor device;

FIG. 3 illustrates a front view of a first embodiment of the invention;

FIG. 4 illustrates a perspective view of a second embodiment of the invention, where the windings are omitted;

FIG. 5a illustrates a front view of a third embodiment of the invention, where the windings are omitted;

FIG. 5b illustrates a side view of FIG. 5a, still with the windings omitted;

FIG. 5c illustrates a perspective view from below of the third embodiment of FIGS. 5a and 5b, still with the windings omitted;

FIG. 6 corresponds to the embodiment in FIG. 5a, where the windings also are shown and where the inductor device is fixed to a printed circuit board;

FIG. 7 illustrates a prior art common mode inductor device for comparison with FIG. 6;

FIGS. 8a and 8b illustrate a fourth embodiment of the invention with the windings omitted.

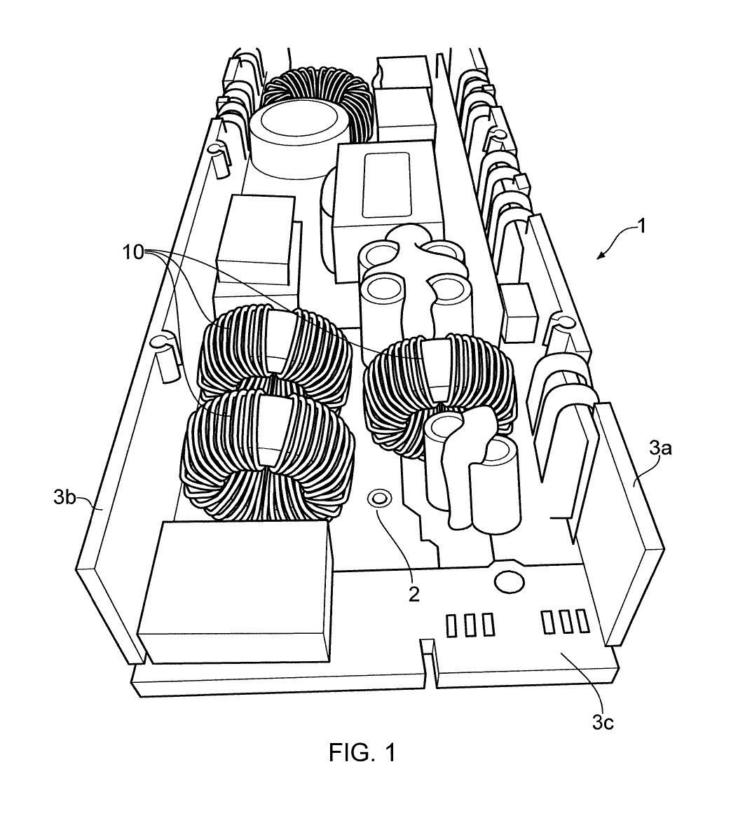

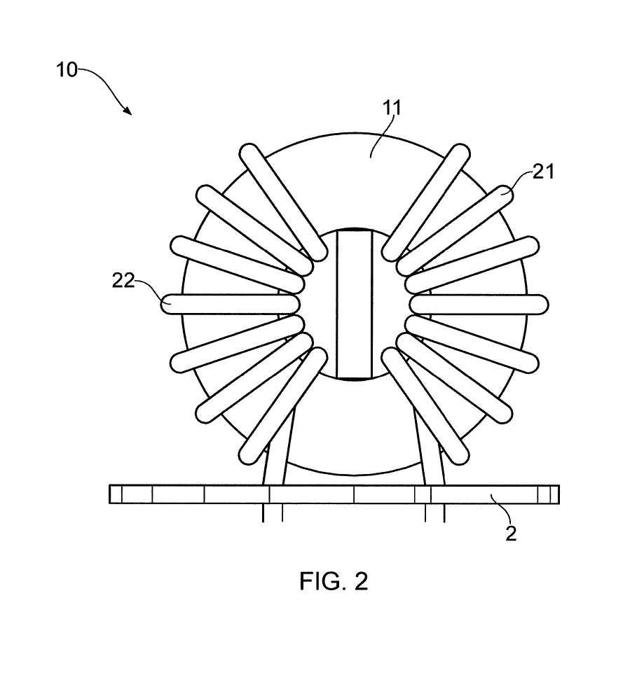

### DETAILED DESCRIPTION

In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention.

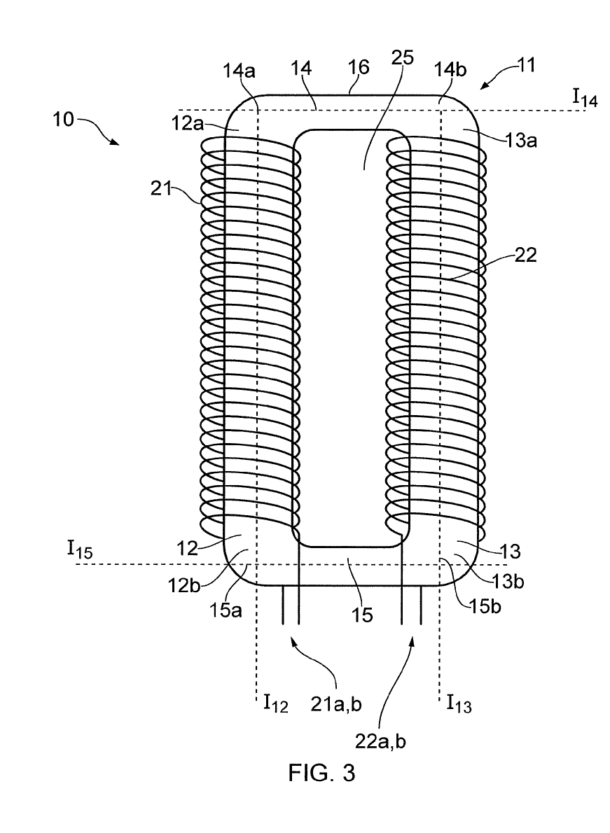

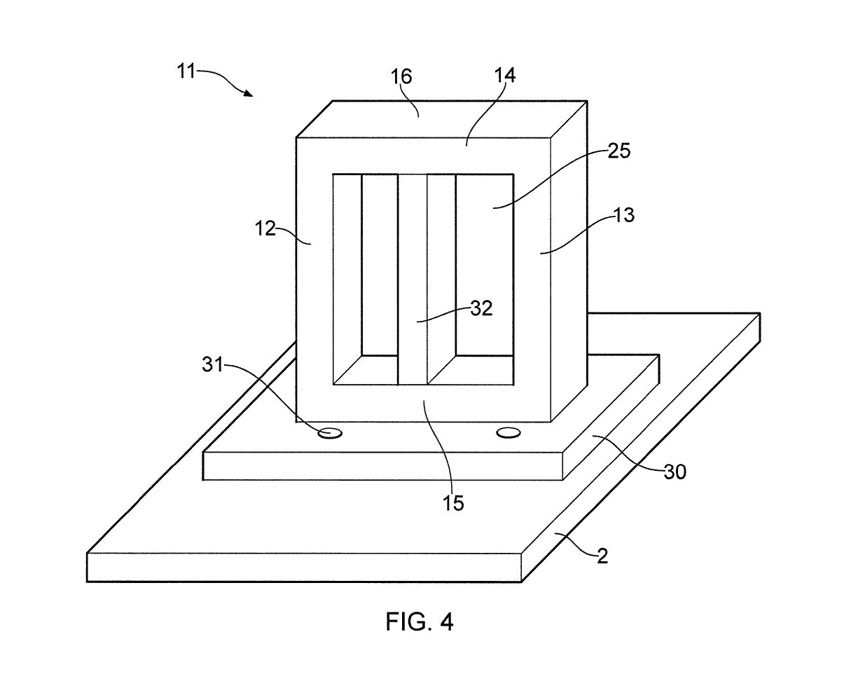

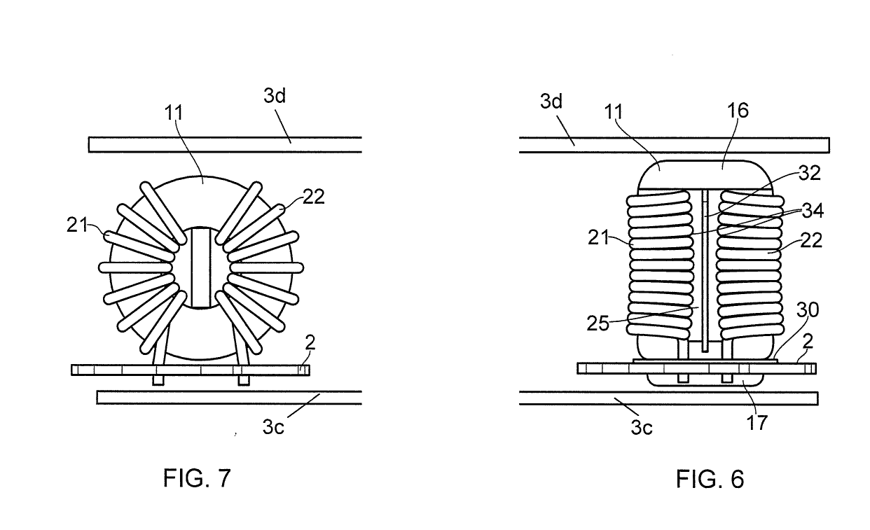

It is now referred to FIG. 3. Here it is shown a common mode inductor device 10 comprising a magnetic core 11, a first winding 21 wound around the magnetic core 11 and a second winding 22 wound around the magnetic core 11. The first winding 21 comprises ends 21a, 21b for connection to a printed circuit board 2 (illustrated in FIGS. 4 and 6) and the second winding 22 comprises ends 22a, 22b for connection to the printed circuit board 2.

The magnetic core 11 comprises a first leg section 12, a second leg section 13, a third leg section 14 and a fourth leg section 15. These leg sections 12, 13, 14, 15 are substantially elongated, each having their respective longitudinal axis I₁₂, I₁₃, I₁₄, I₁₅ as illustrated in FIG. 3.

The first leg section 12 has a first end area 12a and a second end area 12b. The second leg section 13 has a first end area 13a and a second end area 13b. The third leg section 14 has a first end area 14a and a second end area 14b. The fourth leg section 15 has a first end area 15a and a second end area 15b.

The first leg section 12 may be provided in parallel with the second leg section 13, that is, the longitudinal axis I₁₂ is in parallel with the longitudinal axis I₁₃. Moreover, the third leg section 14 may be provided in parallel with the fourth leg section 15, that is, the longitudinal axis I₁₄ is in parallel with the longitudinal axis I₁₅. Moreover, the longitudinal axis I₁₂ of the first leg section 12 is perpendicular to the longitudinal axis I₁₄ of the third leg section 14 and hence also perpendicular to the longitudinal axis I₁₅ of the fourth leg section 15.

The third leg section 14 is provided between the first end area 12a of the first leg section 12 and a first end area 13a of the second leg section 13. The fourth leg section 15 is provided between the second end area 12b of the first leg section 12 and a second end area 13b of the second leg section 13.

It should be noted that the core 11 is forming a continuous loop. That is, the leg sections 12, 13, 14, 15 are forming one continuous loop without air gaps in order to improve the magnetic properties of the core. Preferably, the entire core 11 is produced in one process, for example by a press-molding process of magnetic powder. In such a process, there is no assembly of four separate leg sections.

Alternatively, it may be possible to provide the core 11 as an assembly of leg sections.

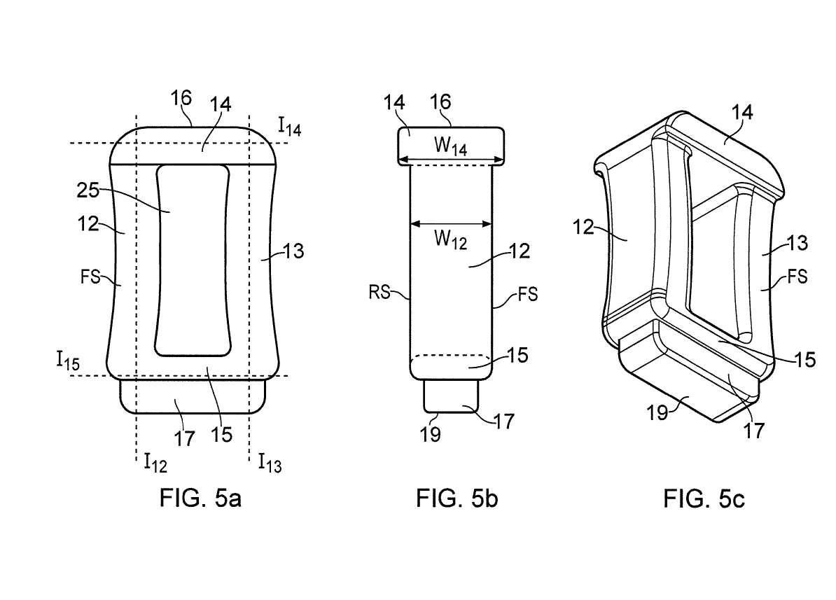

Consequently, the first leg section 12, the second leg section 13, the third leg section 14 and the fourth leg section 15 is forming a rectangular prism with an opening 25. It should be noted that the edges of the leg sections 12, 13, 14, 15 may be chamfered or rounded as shown in FIG. 3 and FIG. 5a, 5c for improving the magnetic properties of the core and in order to reduce the distance between the core and the windings 21, 22 wound around the core 11.

The first winding 21 is wound around the first leg section 12 and the second winding 22 is wound around the second leg section 13. Hence, the first and second windings 21, 22 are substantially parallel to each other, as shown in FIG. 3 and FIG. 6. The fourth leg section 15 may be adapted to be connected to or supported by the printed circuit board 2. The respective ends 21a, 21b, 22a, 22b of the first and second winding 21, 22 are hence provided adjacent to the fourth leg section 15.

It is now referred to FIG. 4, illustrating a sketch of a second embodiment. Here the core is angular, in practice the core 11 will have more rounded or chamfered edges similar to the first embodiment described above or the third embodiment described below. As in the first embodiment, the first winding 21 is wounded around the first leg section 12 and the second winding 22 is wounded around the second leg section 13. However, the windings 21, 22 is omitted from FIG. 4 in order to show the core 11.

In the second embodiment, the common mode inductor device comprises a separation plate 32 provided between the first and second winding 21, 22, that is between the first leg section 12 and the second leg section 13. In the present embodiment, the separation plate 32 is fixed between the third and fourth leg sections 14, 15. The separation plate 32 is made of a plastic material or other known

PCB-material, with appropriate thermal properties, flammability properties and electrically insulating properties. Moreover, it should be mechanically rigid to provide mechanical support for the core 11.

In the second embodiment, the common mode inductor device comprises a mounting plate 30 connected to the fourth leg section 15. The mounting plate 30 provides a mechanical support of the inductor device in relation to the printed circuit board 2.

In FIG. 4 it is shown that the mounting plate 30 comprises openings 31, where the terminals 21a, 21b of the first winding 21 and the terminals 22a, 22b of the second winding 22 are guided through the openings 31 in the mounting plate 30. The ends of the windings are then guided further through the printed circuit board 2 as is known for a skilled person. The mounting plate 30 comprises four openings 31, one for each end 21a, 21b, 22a, 22b of the windings 21, 22.

It should be noted that the first embodiment of FIG. 3 also may comprise a separation plate 32 and/or a mounting plate 30.

It is now referred to FIG. 5a-c, and FIG. 6. The core 11 of FIG. 5a corresponds to the core 11 above, in that the longitudinal axis I₁₂, I₁₃ of the first and second leg section 12, 13 are considered to be parallel to each other, even though these leg sections 12, 13 are slightly curved. The purpose of the curved leg section 12, 13 is to create a small space 34 between the turns of each of the windings 21, 22 in the area close to the separation plate 32 as shown in FIG. 6. The space 34 between each turn of the windings 21, 22 improves the cooling of the inductor device.

In the third embodiment, the fourth leg section 15 comprises a base element 17 protruding away from the first and second leg sections 12, 13, that is, towards the printed circuit board 2. The base element 17 is a part of the continuous core 11. The base element 17 is configured to be supported in an opening of the printed circuit board 2. For example, the base element 17 may be glued to the printed circuit board 2, alternatively, the base element 17 and the opening of the printed circuit board 2 may be shaped so that the base element 17 may be pressed firmly into the opening, and thereby be held supported in the opening in the printed circuit board 2 (i.e. a press fit type of support).

In FIG. 6 it is shown that the base element 17 is protruding from the underside of the printed circuit board 2. The base element 17 is comprises an outer, substantially planar contact surface 19 arranged for contact with the bottom plate 3c of FIG. 6 either directly or via a gap filling material in order to transport heat from the inductor to the bottom plate 3c.

In the third embodiment, as shown in FIG. 5b, it is also the third leg section 14 protrudes from the first and second leg sections 12, 13. Here it is shown that the width W₁₄ of the third leg section 14 is larger than the width W₁₂ of the first leg section 12. It should be noted that the cross sectional area of the core 11 is substantially constant around its circumference.

In FIGS. 5a, 5b and 5c, the front surface of the core is denoted with FS and the rear surface is denoted with RS.

In FIG. 6 it is also shown that the inductor device comprises a mounting plate 30. The mounting plate 30 makes the handling of the core 11 with mounting plate 32 easier during assembly, and may increase the assembly efficiency. Moreover, the mounting plate 32 may also provide electrical insulation.

In all the embodiments above, the third leg section 14 comprises an outer, substantially planar contact surface 16. The contact surface 16 is arranged to be in contact with the roof plate 3d of FIG. 6 either directly or via a gap filling material in order to transport heat from the inductor to the roof plate 3d. The gap filling material must be thermally conducting; in addition it may be electrically insulating and/or shock absorbing.

In the third embodiment, the base element 17 may be in contact with the bottom plate 3c either directly or via the gap filling material.

A prior art common mode inductor is illustrated in FIG. 7 for comparison with the third embodiment of the invention shown in FIG. 6. Here, also the roof panel 3d and the bottom panel 3c are shown, to illustrate the relatively small space available to these components.

By means of the features of the core 11, the windings 21, 22 may have more turns than prior art inductor devices. In FIG. 6 the windings 21, 22 each have 13 turns, while the corresponding windings of FIG. 7 have 7 turns. The increased width W₁₄ allows that the length of each leg section 12, 13 to be increased. The base element 17 being lowered into and below the printed circuit board 2 allows that the length of each leg section 12, 13 to be increased further.

Also the cooling of the inductor device of FIG. 6 is improved over the inductor device in FIG. 7, since the area of the core being available for transporting heat to the housing is substantially increased.

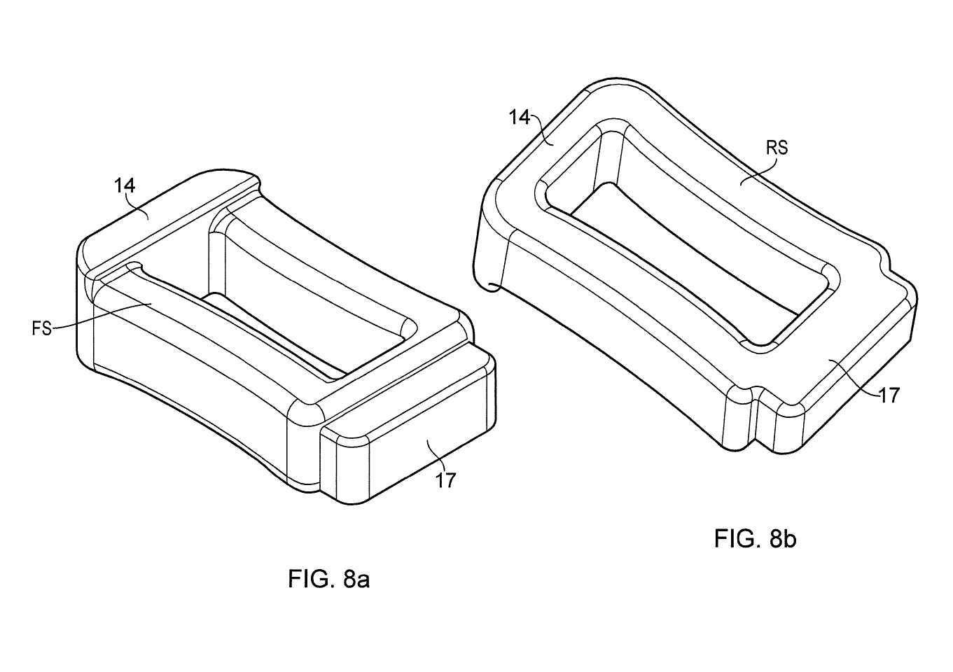

It is now referred to FIGS. 8a and 8b. The core 11 corresponds to the core 11 of FIG. 5a, 5b, 5c, the difference is that the rear surface RS facing down in FIG. 8a and facing up in FIG. 8b, is planar. Hence, the third leg section 14 is only protruding from the front surface FS of the first and second leg sections. The planar rear surface RS provides an easier production process.

One or more embodiments of the present invention also relates to a power supply unit 1 comprising a housing 3 and an AC-DC converter. The housing 3 comprises a roof plate 3d, a bottom plate 3c, two side plates 3a, 3b, a rear plate and a front plate. A fan is provided in the front plate of the housing 3. Ventilating openings provided in the rear plate of the housing 3 for allowing the air to be blown through the housing 3 by means of the fan.

The AC-DC converter comprises electronic components connected to a printed circuit board 2, where the electronic components of the AC-DC converter and the printed circuit board 2 is provided within the housing 3.

The AC-DC converter further comprises three common mode inductor devices 10 of one of the embodiments described above, where the common mode inductor devices 10 are connected to the printed circuit board 2.

As mentioned above, the outer, substantially planar contact surface 16 of the third leg section 14 is provided in contact with the roof plate 3d. A heat conducting and electrically insulating material is provided between the outer, substantially planar contact surface 12 of the third leg section 14 and the roof plate 3d. Moreover, moreover, the base element 17 of the fourth leg section 15 is supported in an opening of the printed circuit board 2.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A common mode inductor device comprising:
a magnetic core foaming a continuous loop;
a first winding wound around the magnetic core;
a second winding wound around the magnetic core,
the magnetic core further comprising:
a first leg section, a second leg section, a third leg section and a fourth leg section, wherein
the first winding is wound around the first leg section, the second winding is wound around the second leg section, the third leg section is provided between a first end area of the first leg section and a first end area of the second leg section, and the fourth leg section is provided between a second end area of the first leg section and a second end area of the second leg section.

2. The common mode inductor device according to claim 1, where the first leg section, the second leg section, the third leg section and the fourth leg section form a rectangular prism with an opening, wherein edges of the leg sections are chamfered or rounded.

3. The common mode inductor device according to claim 1, further comprising a separation plate provided between the first winding and the second winding.

4. The common mode inductor device according to claim 3, wherein the separation plate is fixed between the third and fourth leg sections.

5. The common mode inductor device according to claim 1, further comprising a mounting plate connected to the fourth leg section.

6. The common mode inductor device according to claim 5, wherein the mounting plate comprises openings, wherein first terminals of the first winding and second terminals of the second winding are guided through the openings in the mounting plate.

7. The common mode inductor device according to claim 1, wherein the third leg section comprises an outer, substantially planar contact surface.

8. The common mode inductor device according to claim 1, wherein the magnetic core is made of a press-moulded magnetic powder.

9. The common mode inductor device according to claim 1, wherein the respective ends of the first and second winding are provided adjacent to the fourth leg section.

10. The common mode inductor device according to claim 1, wherein the fourth leg section comprises a base element protruding away from the first and second leg sections, and wherein the base element comprises an outer, substantially planar contact surface.

11. The common mode inductor device according to claim 1, wherein a width of the third leg section is larger a width of the first leg section.

12. The common mode inductor device according to claim 11, wherein a cross sectional area of the core is substantially constant around its circumference.

13. The common mode inductor device according to any one claim 1, wherein a rear surface of the core is planar.

14. A power supply unit comprising:
a housing comprising:
a roof plate, a bottom plate, two side plates, a rear plate and a front plate;
an AC-DC converter comprising:
electronic components connected to a printed circuit board, wherein the electronic components of the AC-DC converter and the printed circuit board are provided within the housing; and
at least two common mode inductor devices according to any one of the above claims, the at least two common mode inductor devices comprising:
a magnetic core forming a continuous loop;
a first winding wound around the magnetic core;
a second winding wound around the magnetic core,
the magnetic core further comprising:
a first leg section, a second leg section, a third leg section and a fourth leg section, wherein the first winding is wound around the first leg section, the second winding is wound around the second leg section, the third leg section is provided between a first end area of the first leg section and a first end area of the second leg section, and the fourth leg section is provided between a second end area of the first leg section and a second end area of the second leg section,
wherein the at least two common mode inductor devices are connected to the printed circuit board.

15. The power supply unit according to claim 14, wherein a width of the third leg section is larger than a width of the first leg section and, wherein the outer, substantially planar contact surface of the third leg section is provided in contact with the roof plate.

16. The power supply unit according to claim 14, wherein a width of the third leg section is larger than a width of the first leg section, and wherein a heat conducting and electrically insulating material is provided between the outer, substantially planar contact surface of the third leg section and the roof plate.

17. The power supply unit according to claim 14, wherein a width of the third leg section is larger than a width of the first leg section, and wherein a base element of the fourth leg section is supported in an opening of the printed circuit board.

18. The common mode inductor device according to claim 2, further comprising a separation plate provided between the first winding and the second winding.

19. The power supply unit according to claim 14, wherein the third leg section comprises an outer, substantially planar contact surface, and wherein the outer, substantially planar contact surface of the third leg section is provided in contact with the roof plate.

20. The power supply unit according to claim 14, wherein the fourth leg section comprises a base element protruding away from the first and second leg sections, and wherein the base element comprises an outer, substantially planar contact surface, and wherein the base element of the fourth leg section is supported in an opening of the printed circuit board.
